(19) United States
(12) Patent Application Publication
(10) Pub. No.: US 2022/0025144 A1
(43) Pub. Date: Jan. 27, 2022

(54) RIGID POLYISOCYANURATE AND POLYURETHANE FOAMS AND METHODS FOR PREPARING THE SAME

(71) Applicant: Dow Global Technologies LLC, Misland, MI (US)

(72) Inventors: Xiaolian Hu, Shanghai (CN); Yanli Feng, Shanghai (CN); Kaisheng Bian, Shanghai (CN); Xiangyang Tai, Shanghai (CN); Yi Zhang, Shanghai (CN); Hongyu Chen, Shanghai (CN); Juelin Liu, Shanghai (CN)

(21) Appl. No.: 17/294,291

(22) PCT Filed: Jan. 8, 2019
(86) PCT No.: PCT/CN2019/070744

§ 371 Date: May 14, 2021

(51) Int. Cl. C08J 9/12; C08G 18/42; C08G 18/32; C08G 18/66; C08G 18/76; C08G 18/18; C08G 18/22; C08G 18/16; C08K 5/521; C08J 9/14; C08J 9/00

(52) U.S. Cl. CPC C08J 9/127; C08J 2375/06; C08G 18/3215; C08G 18/664; C08G 18/7671; C08G 18/1866; C08G 18/225; C08G 18/163; C08K 5/521; C08J 9/125; C08J 9/141; C08J 9/0038; C08J 2201/022; C08J 2203/182; C08J 2203/10; C08J 2203/14; C08G 18/42

(57) ABSTRACT

A composition for preparing polyisocyanurate and polyurethane foams is provided, comprising A) a first isocyanate-reactive component comprising a bisphenol, B) a second isocyanate-reactive component different from the first isocyanate-reactive component, and C) a polyisocyanate component. A method for preparing the polyisocyanurate and polyurethane foams, and foams prepared thereby are also provided.

### FIELD OF THE INVENTION

The present disclosure relates to the field of thermal insulation rigid foams and processes. More particularly, the present disclosure relates to processes and bisphenol-containing compositions to produce rigid polyisocyanurate (PIR) and polyurethane (PUR) foams exhibiting superior thermal insulation and good mechanical properties such as compression strength.

### INTRODUCTION

Rigid polyisocyanurate (PIR) and polyurethane (PUR) foams have outstanding thermal insulation performance and thus can be used in various applications such as building and construction, roofing, tanks, pipes, cold chain and appliances. The reason for these unique characteristics is their cellular structure. With the market demand for better thermal insulation products as well as government regulations on ever higher energy efficiency, there is a critical need to further improve thermal insulation performance of PIR/PUR rigid foam systems. One such solution is to get finer cell sizes to achieve a lower K factor. There remains a need to achieve better thermal insulation and mechanical properties at the same time. Hydrochlorofluorocarbons (HCFC) such as 141b and Hydrofluorocarbon (HFC) such as 245fa are generally used as blowing agents for the preparation of rigid foams with good insulation performance and flame retardancy. Nevertheless, HCFC is known as a main source of global warming and ozone depletion and HFC has an excessively high price. There is also a need to develop a unique technology that minimizes the use of HCFC/HFC blowing agents while still can produce a rigid PUR/PIR foam having excellent insulation performance, flame retardancy performance and mechanical strength.

### SUMMARY OF THE INVENTION

A purpose of the present disclosure is to provide a composition for producing rigid polyisocyanurate (PIR) and polyurethane (PUR) foams. The present disclosure is based on a surprising finding that incorporation of bisphenol in the polyol package of PUR/PIR system at a specific dosage can effectively improve the thermal insulation performance and flame retardancy performance of the resultant rigid PUR/PIR foam while retaining good foam mechanical strength and good processability of the polyol package.

In a first aspect of the present disclosure, the present disclosure provides a composition for preparing rigid polyisocyanurate (PIR) and/or polyurethane (PUR) foams, comprising:

A) a first isocyanate-reactive component comprising a bisphenol represented by Formula 1,

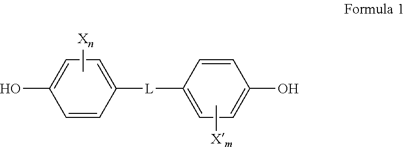

wherein L is a direct bond, an oxygen atom, a sulfur atom,

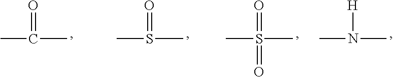

—CH═CH—, or a C₁ to C₈ alkylene group; X and X′ are independently selected from the group consisting of hydrogen atom, halogen atom, and C1-C8 alkyl groups; n and m are independently an integer of 0, 1, 2, 3 or 4; and wherein the amount of the bisphenol is from 5 wt % to 50 wt %, based on the combined weight of the bisphenol and the polyol component; preferably, the polyol is selected from a group consisting of polyether polyols, polyester polyols, and a combination thereof;

B) a second isocyanate-reactive component different from the first isocyanate-reactive component, wherein the second isocyanate-reactive component comprising one or more polyols having a hydroxyl value of 100 to 700 mg KOH/g, e.g., 150 to 700 mg KOH/g, 200 to 700 mg KOH/g, 210 to 640 mg KOH/g, or 240 to 640 mg KOH/g;

C) a polyisocyanate component selected from a group consisting of an aliphatic polyisocyanate comprising at least two isocyanate groups, an aromatic polyisocyanate comprising at least two isocyanate groups, a cycloaliphatic polyisocyanate comprising at least two isocyanate groups, an araliphatic polyisocyanate comprising at least two isocyanate groups, prepolymers thereof, and combinations thereof.

In a second aspect of the present disclosure, the present disclosure provides a polyisocyanurate and polyurethane foam prepared with the composition of the present disclosure, wherein the polyisocyanurate and polyurethane foam is formed by reacting the isocyanate-reactive component with the polyisocyanate component and the bisphenol.

In a third aspect of the present disclosure, the present disclosure provides a method for preparing a polyisocyanurate and polyurethane foam with the composition of the present disclosure, comprising the step of reacting the isocyanate-reactive component with the polyisocyanate component and the bisphenol.

It is to be understood that both the foregoing general description and the following detailed description are exemplary and explanatory only and are not restrictive of the invention as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, the term “composition”, “formulation” or “mixture” refers to a physical blend of different components, which is obtained by mixing simply different components by a physical means.

As disclosed herein, “and/or” means “and, or as an alternative”. All ranges include endpoints unless otherwise indicated.

In various embodiments, a composition for producing rigid polyisocyanurate (PIR) and polyurethane (PUR) foams is provided, comprising a polyisocyanate component having two or more isocyanate groups in each molecule, a first isocyanate-reactive component comprising a bisphenol, a second isocyanate-reactive component including polyols, and optionally a blowing agent, a catalyst, and a flame retardant.

Without being bound by theory, the polyisocyanate component and the isocyanate-reactive components are generally stored in separate containers until the moment when they are blended together and subjected to the polymerization reaction between the isocyanate groups and hydroxyl groups to form polyisocyanurate and polyurethane. Polyurethane refers to a polymer comprising a main chain formed by the repeating unit (—NH—C(O)—O—) derived from the reaction between isocyanate group and hydroxyl group, while polyisocyanurate comprises a polyisocyanurate ring structure formed by trimerization of isocyanate groups.

As used herein, the terms of “polyisocyanurate and polyurethane”, “polyisocyanurate or polyurethane”, “PIR and PUR”, “PIR or PUR” and “PIR/PUR” are used interchangeably and refer to a polymeric system comprising both polyurethane chain and polyisocyanurate groups, with the relative proportions thereof basically depend on the stoichiometric ratio of the polyisocyanate compounds and hydroxyl groups contained in the polyol compounds and the bisphenol. Besides, the ingredients, such as catalysts and other additives, and processing conditions, such as temperature and reaction duration, may also slightly influence the relative amounts of the PUR and PIR in the final foam product. Therefore, polyisocyanurate and polyurethane foam (PIR/PUR foam) as stated in the context of the present invention refer to foam obtained as a product of the reaction between the above indicated polyisocyanates, compounds having isocyanate-reactive groups, particularly, the polyols and the bisphenols. Besides, additional functional groups, e.g., allophanates, biurets or ureas may be formed during the reaction.

The PIR/PUR foam is cellular and can be soft/flexible, hard/rigid or semi-hard/rigid, wherein the soft foam has a high content of open cells. For example, more than 50%, or more than 60%, or more than 70%, or more than 80%, or more than 90%, or more than 95% or the cells in a soft PIR/PUR foam are open to the external environment.

On the other hand, a rigid foam refers to a foam that can withstand a certain load without occurring any noticeable deformation, but will be permanently compressed, damaged or crashed when being subjected to a pressure exceeding a specific threshold. The cells in the rigid foam are mostly closed. For example, the ratio of closed cells in the rigid foam can be more than 50%, or more than 60%, or more than 70%, or more than 80%, or more than 90%, or more than 95%.

Without being bound by theory, it is believed that the proportion of open and closed cells in a foam mainly depends on the categories and contents of the raw materials such as the polyisocyanate components, the polyols and the bisphenol. Meanwhile, the blowing agent, catalyst, the solvent (if any) and the processing conditions may also influence the open cell rate and the rigidity/flexibility of the resultant PIR/PUR foam to a limited extent.

According to the embodiments of the present disclosure, the PIR/PUR foam prepared by the unique composition of the present application is a rigid foam. According to the embodiments of the present disclosure, the PIR/PUR foam prepared by the unique method of the present application is a rigid foam.

The composition of the present disclosure may further comprise catalyst, blowing agent, flame retardant and other additives.

According to an embodiment of the present disclosure, the composition of the present disclosure is generally prepared and stored as two separate “packages”, i.e., an isocyanate package solely comprising the polyisocyanate component and a polyol package comprising any other components. Namely, the two isocyanate-reactive components, catalyst, blowing agent, flame retardant and other additives may be mixed together to obtain a “polyol package”, which is then blended with the isocyanate package to produce the PUR/PIR foam. According various embodiments of the present disclosure, the amounts, contents or concentration of the isocyanate-reactive components and the polyisocyanate component are calculated based on the total weight of the composition, i.e., combined weight of the “polyol package” and the “isocyanate package”, the content of the bisphenol is based on the combined amount of the components donating hydroxyl group to react with the isocyanate group, and particularly, the combined weight of the two isocyanate-reactive components, while the contents of the other components, e.g., the catalyst, blowing agent, flame retardant and other additives, are based on the weight of the “polyol package”, i.e., the combined weight of all the components excluding the polyisocyanate component or the total weight of the composition minus the weight of the polyisocyanate component. In alternative embodiments, the catalyst, blowing agent, blame retardant and other additives are not mixed with the isocyanate-reactive components and are added as independent streams, but the contents thereof are still calculated based on the combined weight of the “polyol package”.

The First Isocyanate-Reactive Component

Without being bound by theory, it is believed that the use of a first isocyanate-reactive component comprising the bisphenol molecules represented by Formula I at an amount of 5 wt % to 50 wt %, or 10 wt % to 30 wt %, or from 5 wt % to 25 wt %, or from 5 wt % to 15 wt %, based on the combined weight of the bisphenol and the polyol (i.e., the first and the second components), can result a polyol package with good processability, and such a polyol package can react with the polyisocyanate to produce a PIR/PUR rigid foam showing significantly improved thermal insulation performance and compression strength. It is also surprisingly discovered that the incorporation of a certain amount of bisphenol in the polyol package enables the inventor to minimize the undesirable use of HCFC and HFC blowing agents while still achieving superior insulation performance, flame retardant performance without deteriorating the mechanical strength.

An typical bisphenol can be represented by the following Formula 1,

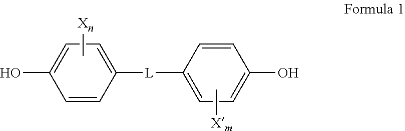

wherein L is a direct bond, an oxygen atom, a sulfur atom,

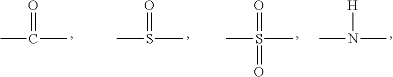

—CH═CH— or a C₁ to C₈ alkylene group; X and X′ are independently selected from the group consisting of hydrogen atom, halogen atom, and C1-C8 alkyl groups; n and m are independently an integer of 0, 1, 2, 3 or 4. The term “direct bond” refers to the situation in which the two phenyl rings in said formula 1 are directly bonded with each other without any intermediate atom. According to an embodiment, L is an alkylene group selected from the group consisting of di(methyl)methylene, methylene, 1,1′, 2, 2′-tetra(methyl)ethylene, ethylene, 1, 1′, 2, 2′, 3, 3′-hexa(methyl)propylene, 1,3-propylene, 1,4-butylene, pentamethylene, hexamethylene and heptamethylene. According to an embodiment, X and X′ are independently selected from the group consisting of hydrogen atom, halogen atom, methyl, ethyl, n-propyl, i-propyl, n-butyl, s-butyl, i-butyl and t-butyl. According to an embodiment, the bisphenol comprises bisphenol A (BPA), 2,2-bis-(p-hydroxyphenyl)-propane, 4,4′-biphenol, 4,4′-oxydiphenol, or any combinations thereof.

According to various embodiments of the present application, the bisphenol is provided in the polyol package. If the bisphenol molecule is solid, it can be firstly dissolved in the polyol under mixing and heating.

Without being bound by theory, it is believed that the bisphenol also provides hydroxyl groups which react with the isocyanate group to form the polyurethane product. According to one embodiment of the present application, the amount of the hydroxyl groups provided by the bisphenol is less than 50 wt %, e.g., from 10 wt % to 30 wt %, or from 5 wt % to 25 wt %, or from 5 wt % to 15 wt %, based on the total molar content of the reactive OH groups contained in the polyol package, and particularly, the combination of the bisphenol and the polyols.

According to an embodiment of the disclosure, the stoichiometric ratio of the isocyanate groups in the polyisocyanate component to the hydroxyl groups in the two isocyanate-reactive components is at least 1.0, preferably between about 1.0 and 6, preferably from 1.1 to 6, and more preferably from 1.2 to 4.

The Second Isocyanate-Reactive Component

As used herein, the “second isocyanate-reactive component” is different from the first isocyanate reactive component and does not comprise bisphenol represented by Formula I. In a preferable embodiment, the second isocyanate-reactive component does not comprise any bisphenol, hence the composition of the present disclosure does not comprise any bisphenol besides those provided by the first isocyanate reactive component. In another embodiment, the second isocyanate-reactive component comprises additional bisphenol different from those represented by above Formula I at an amount of up to 50 wt %, up to 30 wt %, up to 20 wt %, up to 10 wt %, up to 5 wt %, up to 2 wt %, up to 1 wt % or up to 0.1 wt %, based on the total weight of the second isocyanate-reactive component. In various embodiments of the present disclosure, the second isocyanate-reactive component comprises one or more polyols selected from the group consisting of aliphatic polyhydric alcohols comprising at least two hydroxy groups, cycloaliphatic or aromatic polyhydric alcohols comprising at least two hydroxy groups, araliphatic polyhydric alcohols comprising at least two hydroxy groups, polyether polyol, polyester polyol and mixture thereof. Preferably, the polyol is selected from the group consisting of C2-C16 aliphatic polyhydric alcohols comprising at least two hydroxy groups, C6-C15 cycloaliphatic or aromatic polyhydric alcohols comprising at least two hydroxy groups, C7-C15 araliphatic polyhydric alcohols comprising at least two hydroxy groups, polyester polyols having a molecular weight from 100 to 5,000, polyether polyols having a molecular weight from 100 to 5,000, and combinations thereof.

In a preferable embodiment, the second isocyanate-reactive component comprises a mixture of two or more different polyols, such as a mixture of two or more polyether polyols, a mixture of two or more polyester polyols, or a mixture of at least one polyether polyols with at least one polyester polyols.

In an alternative embodiment, the second isocyanate-reactive component has a functionality (average number of isocyanate-reactive groups, particularly, hydroxyl group, in a polyol molecule) of at least 2.0 and an OH value of 100 to 2,000 mg KOH/g, preferably 150 to 2,000 mg KOH/g, preferably 200 to 2,000 mg KOH/g, preferably from 210 to 1,000 mg KOH/g, preferably from 150 to 700 mg KOH/g, preferably from 210 to 640 mg KOH/g, and more preferably from 240 to 640 mg KOH/g.

The polyester polyol is typically obtained by condensation of polyfunctional alcohols having from 2 to 12 carbon atoms, preferably from 2 to 6 carbon atoms, with polyfunctional carboxylic acids having from 2 to 12 carbon atoms, preferably 2 to 6 carbon atoms. Typical polyfunctional alcohols for preparing the polyester polyol are preferably diols or triols and include ethylene glycol, propylene glycol, butylene glycol, pentylene glycol or hexylene glycol. Typical polyfunctional carboxylic acids are selected from the group consisting of succinic acid, glutaric acid, adipic acid, suberic acid, azelaic acid, sebacic acid, decanedicarboxylic acid, maleic acid, fumaric acid and preferably phthalic acid, isophthalic acid, terephthalic acid, the isomeric naphthalenedicarboxylic acids, and the anhydrides and combinations thereof. The polyester polyol is preferably terminated with at least two hydroxyl groups. In a preferable embodiment, the polyester polyol has a hydroxyl functionality of 2 to 10, preferably from 2 to 6. In another embodiment, the polyester polyol has an OH value of 100 to 2,000 mg KOH/g, preferably 150 to 2,000 mg KOH/g, preferably 200 to 2,000 mg KOH/g, preferably from 210 to 1,000 mg KOH/g, preferably from 150 to 700 mg KOH/g, preferably from 210 to 640 mg KOH/g, and more preferably from 240 to 640 mg KOH/g.

Various molecular weights are contemplated for the polyester polyol. For example, the polyester polyol may have a number average molecular weight of from about 100 g/mol to about 4,000 g/mol, preferably from about 150 g/mol to about 3,000 g/mol, preferably from about 200 g/mol to about 2,000 g/mol, preferably from about 250 g/mol to about 1,000 g/mol, preferably from about 280 g/mol to about 500 g/mol, and more preferably from about 300 g/mol to about 350 g/mol.

The polyether polyols usually have a hydroxyl functionality between 2 and 8, in particular from 2 to 6 and is generally prepared by polymerization of one or more alkylene oxides selected from propylene oxide (PO), ethylene oxide (EO), butylene oxide, tetrahydrofuran and mixtures thereof, with proper starter molecules in the presence of catalyst. Typical starter molecules include compounds having at least 2, preferably from 4 to 8 hydroxyl groups or having two or more primary amine groups in the molecule. Suitable starter molecules are for example selected from the group comprising aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. By way of starter molecules having at least 2 and preferably from 2 to 8 hydroxyl groups in the molecule it is preferable to use trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Catalyst for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In an embodiment of the present disclosure, the polyether polyol has a number average molecular weight in the range from 100 to 10,000 g/mol, preferably in the range from 200 to 8,000 g/mol, more preferably in the range from 300 to 6,000 g/mol, more preferably in the range from 400 to 4,000 g/mol and more preferably in the range from 500 to 3,000 g/mol. In one embodiment, the polyether polyol has an OH value of 100 to 2,000 mg KOH/g, preferably 150 to 2,000 mg KOH/g, preferably 200 to 2,000 mg KOH/g, preferably from 210 to 1,000 mg KOH/g, preferably from 150 to 700 mg KOH/g, preferably from 210 to 640 mg KOH/g, and more preferably from 240 to 640 mg KOH/g.

In general, the concentration of the polyol component used herein may range from about 10 wt % to about 50 wt %, preferably from about 15 wt % to about 40 wt %, preferably from about 20 wt % to about 35 wt %, preferably from about 20 wt % to about 70 wt %, preferably from about 30 wt % to about 60 wt %, preferably from about 35 wt % to about 50 wt %, based on the total weight of all components in the composition for preparing the PUR/PIR foam.

Polyisocyanate component

In various embodiments, the polyisocyanate component has an average functionality of at least about 2.0, preferably from about 2 to 10, more preferably from about 2 to about 8, and most preferably from about 2 to about 6. In some embodiments, the polyisocyanate component includes a polyisocyanate compound comprising at least two isocyanate groups. Suitable polyisocyanate compounds include aromatic, aliphatic, cycloaliphatic and araliphatic polyisocyanates having two or more isocyanate groups. In a preferable embodiment, the polyisocyanate component comprises polyisocyanate compounds selected from the group consisting of C₄-C₁₂ aliphatic polyisocyanates comprising at least two isocyanate groups, C₆-C₁₅ cycloaliphatic or aromatic polyisocyanates comprising at least two isocyanate groups, C₇-C₁₅ araliphatic polyisocyanates comprising at least two isocyanate groups, and combinations thereof. In another preferable embodiment, suitable polyisocyanate compounds include m-phenylene diisocyanate, 2,4-toluene diisocyanate and/or 2,6-toluene diisocyanate (TDI), the various isomers of diphenylmethanediisocyanate (MDI), carbodiimide modified MDI products, hexamethylene-1,6-diisocyanate, tetramethylene-1,4-diisocyanate, cyclohexane-1,4-diisocyanate, hexahydrotoluene diisocyanate, hydrogenated MDI, naphthylene-1,5-diisocyanate, or mixtures thereof.

Alternatively or additionally, the polyisocyanate component may also comprise a isocyanate prepolymer having an isocyanate functionality in the range of 2 to 10, preferably from 2 to 8, more preferably from 2 to 6. The isocyanate prepolymer can be obtained by reacting the above stated monomeric isocyanate components with one or more isocyanate-reactive compounds selected from the group consisting of ethylene glycol, 1,2-propanediol, 1,3-propanediol, 1,3-butanediol, 1,4-butenediol, 1,4-butynediol, 1,5-pentanediol, neopentylglycol, bis(hydroxy-methyl) cyclohexanes such as 1,4-bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols. Suitable prepolymers for use as the polyisocyanate component are prepolymers having NCO group contents of from 2 to 40 weight percent, more preferably from 4 to 30 weight percent. These prepolymers are preferably prepared by reaction of the di- and/or poly-isocyanates with materials including lower molecular weight diols and triols. Individual examples are aromatic polyisocyanates containing urethane groups, preferably having NCO contents of from 5 to 40 weight percent, more preferably 20 to 35 weight percent, obtained by reaction of diisocyanates and/or polyisocyanates with, for example, lower molecular weight diols, triols, oxyalkylene glycols, dioxyalkylene glycols, or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene- polyoxyethylene glycols can be used. Polyester polyols can also be used, as well as alkane diols such as butane diol. Other diols also useful include bishydroxyethyl- or bishydroxypropyl-bisphenol A, cyclohexane dimethanol, and bishydroxyethyl hydroquinone.

Also advantageously used for the polyisocyanate component are the so-called modified multifunctional isocyanates, that is, products which are obtained through chemical reactions of the above isocyanates compounds. Exemplary are polyisocyanates containing esters, ureas, biurets, allophanates and preferably carbodiimides and/or uretoneimines Liquid polyisocyanates containing carbodiimide groups, uretoneimines groups and/or isocyanurate rings, having isocyanate groups (NCO) contents of from 120 to 40 weight percent, more preferably from 20 to 35 weight percent, can also be used. These include, for example, polyisocyanates based on 4,4′- 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI; and mixtures of toluene diisocyanates and PMDI and/or diphenylmethane diisocyanates.

Generally, the amount of the polyisocyanate component may vary based on the end use of the rigid PIR/PUR foam. For example, as one illustrative embodiment, the concentration of the polyisocyanate component can be from about 45 wt % to about 90 wt %, preferably from about 60 wt % to about 85 wt %, preferably from about 65 wt % to about 80 wt %, preferably from about 30 wt % to about 80 wt %, preferably from about 40 wt % to about 80 wt %, preferably from about 50 wt % to about 75 wt %, based on the total weight of all the components in the composition for preparing the rigid PIR/PUR foam.

Blowing agent

In various embodiments, the blowing agent may be selected based at least in part on the desired density of the final foam. The blowing agent may be added to the polyol package before the polyol package is combined with the polyisocyanate component. Without being bound by theory, the blowing agent may absorb heat from the exothermic reaction of the combination of the isocyanate component with the isocyanate-reactive compounds and vaporize and provide additional gas useful in expanding the polyurethane foam to a lower density. In various embodiments, the blowing agent can be water, hydrocarbons, hydrofluorocarbons, or any mixtures thereof. The blowing agent may comprise, by way of example and not limitation, butane, isobutane, 2,3-dimethylbutane, n- and i-pentane isomers, hexane isomers, heptane isomers, cycloalkanes including cyclopentane (c-pentane), cyclohexane, cycloheptane, and combinations thereof, HFC-245fa (1,1,1,3,3-pentafluoropropane, HFC-365mfc (1,1,1,3,3 -penta-flurobutane), HFC-227ea (1,1,1,2,3,3,3-heptafluropropane), HFC-134a (1,1,1,2-tetrafluroethane), combinations thereof, and the like. In one embodiment, the blowing agent is water. In various embodiments, the amount of blowing agent is from about 0.01 wt % to about 40 wt %, more preferably 3 wt % to about 30 wt %, more preferably from 5 wt % to 28 wt %, and the most preferably from 10 wt % to 25 wt %, based on the total weight of the “polyol package”. According to one embodiment of the present disclosure, the combined content of hydrofluorocarbons in the blowing agent is at most 75 wt %, preferably from 20 wt % to 75 wt %, preferably from 30 wt % to 70 wt %, preferably from 40 wt % to 60 wt %, preferably from 50 wt % to 55 wt %, based on the weight of the blowing agent. According to an alternative embodiment of the present disclosure, the combined content of hydrocarbons in the blowing agent is from 25 wt % to 80 wt %, preferably from 30 wt % to 70 wt %, preferably from 40 wt % to 60 wt %, preferably from 50 wt % to 55 wt %, based on the weight of the blowing agent.

Catalyst

Catalyst may include urethane reaction catalyst and isocyanate trimerization reaction catalyst.

Trimerization catalysts may be any trimerization catalyst known in the art that will catalyze the trimerization of an organic isocyanate compound. Trimerization of isocyanates may yield polyisocyanurate compounds inside the polyurethane foam. Without being limited to theory, the polyisocyanurate compounds may make the polyurethane foam more rigid and provide improved reaction to fire. Trimerization catalysts can include, for example, glycine salts, tertiary amine trimerization catalysts, alkali metal carboxylic acid salts, and mixtures thereof. In some embodiments, sodium N-2-hydroxy-5-nonylphenyl-methyl-N-methylglycinate may be employed. When used, the trimerization catalyst may be present in an amount of 0.5-3 wt %, preferably 0.8-2 wt % of the “polyol package”.

Tertiary amine catalysts include organic compounds that contain at least one tertiary nitrogen atom and are capable of catalyzing the hydroxyl/isocyanate reaction between the isocyanate component and the isocyanate reacting mixture. Tertiary amine catalysts can include, by way of example and not limitation, triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N, N′, N″-tris(dimethyl amino-propyl)sym-hexahydrotriazine, and mixtures thereof. When used, the tertiary amine catalyst may be present in an amount of 0.5-3 wt %, preferably 0.8-2 wt % of the “polyol package”.

The composition of the present disclosure may further comprise the following catalysts: tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride, stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt.

The total amount of the catalyst component used herein may range generally from about 0.01 wt % to about 10 wt % in polyol package in one embodiment, and from 0.5 wt % to about 5 wt % in polyol package in another embodiment.

Flame Retardant

In various embodiments, fire resistance performance may be enhanced by including one or more flame retardants. Flame retardants may be brominated or non-brominated and may include, by way of example and not limitation, triethyl phosphate, tris(1,3-dichloropropyl)phosphate, tris(2-choroethyl)phosphate, tris(2-chloropropyl)phosphate, diammonium phosphate, various halogenated aromatic compounds, antimony oxide, alumina trihydrate, and combinations thereof. When used, the flame retardant may be present in an amount from 1 wt % to about 30 wt %, or about 10 wt % to about 30 wt %, or about 15 wt % to about 25 wt % of the polyol package.

Other additives

Other optional compounds or additives that may be added to composition of the present invention may include, for example, other co-catalysts, surfactants, toughening agents, flow modifiers, adhesion promoters, diluents, stabilizers, plasticizers, catalyst de-activators, dispersing agents and mixtures thereof.

Surfactants, especially organic surfactants, may be added to serve as cell stabilizers. Some representative surfactants include organic surfactants containing polyoxy-ethylene-polyoxybutylene block copolymers. It is particularly desirable to employ a minor amount of a surfactant to stabilize the foaming reaction mixture until it cures. Other surfactants that may be useful herein are polyethylene glycol ethers of long-chain alcohols, tertiary amine or alkanolamine salts of long-chain allyl acid sulfate esters, alkylsulfonic esters, alkyl arylsulfonic acids, and combinations thereof. Such surfactants are employed in amounts sufficient to stabilize the foaming reaction against collapse and the formation of large uneven cells. Typically, a surfactant total amount from about 0.2 to about 3 wt %, based on the amount of the polyol package, is sufficient for this purpose.

Other additives such as fillers and pigments may be included in the inventive rigid PIR/PUR foam compositions. Such fillers and pigments may include, in non-limiting embodiments, barium sulfate, calcium carbonate, graphite, carbon black, titanium dioxide, iron oxide, microspheres, alumina trihydrate, wollastonite, glass fibers, polyester fibers, other polymeric fibers, combinations thereof, and the like.

Manufacture Technology

In various embodiments, the PIR/PUR foam is prepared by mixing the reaction components, including the two isocyanate reactive components, the catalyst, the blowing agents and any other additives of the “polyol package”, with the isocyanate package at room temperature or at an elevated temperature of 30 to 120° C., preferably from 40 to 90° C., more preferably from 50 to 70° C., for a duration of e.g., 10 seconds to 10 hours, preferably from 2 minutes to 3 hours, more preferable from 10 minutes to 60 minutes. In some embodiments, the polyols, the blowing agent and the bisphenol may be mixed prior to or upon addition to the isocyanate component. Other additives, including catalysts, flame retardants, and surfactants, may be added to the polyol package prior to addition of the blowing agent. Mixing may be performed in a spray apparatus, a mix head, or a vessel. Following mixing, the mixture may be sprayed or otherwise deposited onto a substrate or into an open mold. Alternatively, the mixture may be injected inside a cavity, in the shape of a panel or any other proper shapes. This cavity may be optionally kept at atmospheric pressure or partially evacuated to sub-atmospheric pressure.

Upon reacting, the mixture takes the shape of the mold or adheres to the substrate to produce a PIR/PUR foam which is then allowed to cure, either partially or fully. Suitable conditions for promoting the curing of the PIR/PUR polymer include a temperature of from about 20° C. to about 150° C. In some embodiments, the curing is performed at a temperature of from about 30° C. to about 75° C. In other embodiments, the curing is performed at a temperature of from about 35° C. to about 60° C. In various embodiments, the temperature for curing may be selected at least in part based on the time duration required for the PUR/PIR polymer to gel and/or cure at that temperature. Cure time will also depend on other factors, including, for example, the particular components (e.g., catalysts and quantities thereof), and the size and shape of the article being manufactured.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments, within the scope of the claims, will be apparent from consideration of the specification and/or practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto.

### EXAMPLES

Some embodiments of the invention will now be described in the following examples, wherein all parts and percentages are by weight unless otherwise specified.

The information of the raw materials used in the examples is listed in the following Table 1. All the raw materials were directly used as received without further purification and the water is distilled water.

TABLE 1
Raw materials

| Materials | Description | Vendor |
|---|---|---|
| STEPANPOL PS2412 | Polyester polyol having an OH value of around | STEPAN |
| | 240 mg KOH/g and a viscosity of around 3000 | |
| | cps at 25° C. | |
| STEPANPOL PS3024 | Polyester polyol with an OH value of around 310 | STEPAN |
| | mg KOH/g and a viscosity of around 7000 cps at | |
| | 25° C. | |
| VORANOL 482 | A PO based Polyether polyol having a hydroxyl | Dow |
| | functionality of 6 and an OH value of 482 mg | |
| | KOH/g | |
| VORANOL 1490 | A PO based Polyether polyol having a hydroxyl | Dow |
| | functionality of 4.3 and an OH value of 490 mg | |
| | KOH/g | |
| VORANOL RA 640 | A PO based Polyether polyol having a hydroxyl | Dow |
| | functionality of 4 and an OH value of 640 mg | |
| | KOH/g | |
| VORANOL SD 301 | A PO based Polyether polyol having a hydroxyl | Dow |
| | functionality of 3 and an OH value of 156 mg | |
| | KOH/g | |
| Bisphenol A (BPA) | White powder with an OH value of around 492 mg | Sinopharm Chemical |
| | KOH/g | Reagent Co., Etd. |
| | | (“SCRC”) |
| 4,4′-Oxydiphenol | White powder with an OH value of around 555 | SCRC |
| 4,4′-Biphenol | White powder with an OH value of around 602 | SCRC |
| Triethyl Phosphate | Flame retardant | Jiangsu Yoke, ICE |
| (TEP) | | |
| Trichloropropyl | Flame retardant | Jiangsu Yoke, ICE |
| phosphate (TCPP) | | |
| AK8825 | Silicon surfactant | Jiangsu Maysta, ICL |
| Dabco K2097 | Catalyst, a solution of potassium acetate in | Air Products |
| | diethylene glycol | |
| Polycat 5 (PC-5) | Catalyst, pentamethyldiethylenetriamine | Air Products |
| Polycat 8 (PC-8) | Amine catalyst, N,N-dimethylcyclohexylamine | Air Products |
| Dabco TMR-30 | Amine catalyst, | Air Products |
| | 2,4,6-tri(dimethylaminemethyl)phenol | |
| Water | Blowing agent | / |
| Cyclopentane (CP) | Blowing agent | Beijing Eastern |
| | | Acrylic Chemical |
| HFC-245fa | Blowing agent, 1,1,1,3,3-pentafluoropropane | Honeywell |
| PAPI 135C | Polymeric MDI with a NCO content of 31 wt % | Dow |
| VORANATE M600 | Polymeric MDI with a NCO % of 30.5, an average | Dow |
| | functionality of 2.8 and a viscosity at 25° C. | |
| | of 600 mPa · s | |

The Inventive Examples 1-6 and Comparative Examples 1-3 were performed by a hand foaming technology or a high pressure machine foaming technology as follows:

The hand foaming technology comprises the steps of weighing the second isocycnate-reactive component (polyol), surfactant, flame retardant, catalyst and water according to the formulations of Table 2 in a paper cup and mixing them with a high speed mixer (from Heidolph) at a rotation speed of 2000 r/m for 10 min to produce the “polyol package”; for Inventive examples 1 to 6, the solid bisphenol was also dissolved in the above said polyol package in a sealed bottle by heating at 80° C. for two hours; stiffing the polyol package at a speed of 2000 r/m for 5 min, and then cooling it to room temperature; adding a targeted amount of blowing agent into the paper cup under thorough mixing, followed by a subsequent addition of the desired amount of a polyisocyanate component into the paper cup. All the substances in the paper cup were immediately mixed by a high speed mixer at a speed of 3000 r/m for 6 seconds and poured into a mold of the size 10 cm×20 cm×30 cm that had been preheated to 55° C. and placed vertically along the length direction for foaming. The foam was removed from the mold after about 30 min and placed in the lab bench overnight prior to physical properties testing.

The high pressure machine foaming technology was performed with a high pressure machine (CANNON A-CMPT 40 FC PB). Flammable CP was used as the blowing agent. For the experiments comprising bisphenol A in the polyol package, bisphenol was dissolved into polyol package beforehand (by heating at 80° C. for 2 to 3 hours in a sealed bucket) to produce a clear solution (the polyol package). The polyol package was stirred by a high speed hand-mixer for 3 minutes, and then cooled to room temperature. A targeted amount of blowing agent was then added into the bucket and was mixed with the polyol package for additional 3 minutes. A 1.1 meter mold having a dimension of 110 cm×30 cm×5 cm and a jumbo mold having a dimension of 70 cm×40 cm×10 cm were used for this machine foaming. The “polyol package” and corresponding polyisocyanate component, which were stored in separate pots, were rapidly mixed together with an impingement mixer (having a pump pressure of 100 bar) and introduced into each of the above stated mold which had been preheated to 55° C. where the mixed substances were allowed to react and expand.

The technologies for characterizing the viscosity of the polyol, the thermal conductivity (K factor), density and compression strength of the resultant rigid PIR/PUR foams are described as follows.

Polyol viscosity

Viscosity measurements were performed on a TA Instruments AR 2000ex rheometer with a 40mm Aluminum plate. Data were collected at a constant frequency of 6.28 rad/s and a constant strain 1%, temperature ramp from 20° C. to 80° C. at a ramp rate of 3° C./min.

Thermal conductivity (K-factor)

Foam specimens with a size of 20 cm×20 cm×2.5 cm were cut from the central position of the foams approximately 24 hours after the foams were produced and were subjected to characterization on a HC-074 heat flow meter instrument (EKO Instrument Trading Co., Ltd.) at 10° C. (with a lower plate temperature of 18° C. and a upper plate temperature of 2° C.) and 23° C. (with a lower plate temperature of 36° C. and a upper plate temperature of 10° C.) according to ASTM C518-04. The measured value of the K-factor exhibits a variance of ±0.1 mW/m*K.

Foam Density

The density of the rigid foams was measured according to ASTM 1622-03. In particular, foam specimens measuring 20 cm×20 cm×2.5 cm were cut from the central position of the foams approximately 24 hours after the foams were produced. The weight and exact dimension of the sample were measured, and the density was calculated accordingly. The measured value of the foam density exhibits a variance of around ±0.1 kg/m³.

Compression Strength

The compression strength was measured on a rigid foam with a size of 5 cm×5 cm×5 cm according to EN 826.

Flame Retardant Performance Test

The Flame Retardant Performance was characterized according to GB/T8332-2008.

Comparative Examples 1 to 2 and Inventive Examples 1 to 5 were performed with the hand foaming technology by using the formulations shown in Table 2, and Comparative

Example 3 and Inventive Example 6 were performed with the high pressure machine foaming technology by using the formulations shown in Table 3. The formulations for all the Comparative Examples and Inventive Examples were particularly designed, and different amounts of the polyisocyanate component were used, to achieve an identical NCO index of 4. Besides, the amount of the other components were also tuned in order to maintain identical blowing agent percentage and catalyst percentage.

TABLE 2
The formulations of the Inventive Examples (IE) 1 to 5 and Comparative Examples
(CE) 1 to 2, wherein the unit for the amount of each ingredient was gram.

| | CE 1 | CE 2 | IE 1 | IE 2 | IE 3 | IE 4 | IE 5 |
|---|---|---|---|---|---|---|---|
| PS 3024 | 21.25 | 21.25 | 16.25 | 11.25 | 6.25 g | 6.25 g | 11.25 |
| Bisphenol A | — | — | 5 | 10 | 15 | | |
| 4,4′- | | | | | | 15 | |
| Oxydiphenol | | | | | | | |
| 4,4′-Biphenol | | | | | | | 10 |
| PS 2412 | 63.75 | 63.75 | 63.75 | 63.75 | 63.75 | 63.75 | 63.75 |
| TEP | 15 | 10 | 15 | 15 | 15 | 15 | 15 |
| AK8825 | 3 | 3 | 3 | 3.12 | 3.25 | 3.34 | 3.28 |
| K2097 | 1.9 | 1.9 | 1.9 | 1.98 | 2.06 | 2.11 | 2.08 |
| PC-5 | 1 | 1 | 1 | 1.04 | 1.08 | 1.11 | 1.09 |
| water | 0.8 | 0.8 | 0.8 | 0.83 | 0.86 | 0.88 | 0.87 |
| CP | 21 | 21 | 21 | 21.88 | 22.7 | 23.30 | 23.00 |
| M600 | 260 | 260 | 260 | 275 | 290 | 300 | 292 |

TABLE 3
The formulations of the Inventive Example (IE) 6
and Comparative Example (CE) 3, wherein the unit
for the amount of each ingredient was kilogram.

| | |
|---|---|
| CE 3 | IE 6 |

| | | | | |
|---|---|---|---|---|
| PS 3024 | 6.375 | kg | 1.875 | kg |

| | | | |
|---|---|---|---|
| Bisphenol A | 0 | 4.5 | kg |

| | | | | |
|---|---|---|---|---|
| PS 2412 | 19.135 | kg | 19.135 | kg |
| TEP | 4.5 | kg | 4.5 | kg |
| AK8825 | 0.9 | kg | 0.975 | kg |
| K2097 | 0.573 | kg | 0.618 | kg |
| PC-5 | 0.3 | kg | 0.324 | kg |
| water | 0.233 | kg | 0.252 | kg |
| CP | 6.363 | kg | 6.878 | kg |
| PAPI 135C | 78 | kg | 87 | kg |

The viscosity of the polyol, the thermal conductivity (K factor), density and compression strength of the resultant rigid PIR/PUR foams were characterized and summarized in Table 4.

TABLE 4
Polyol viscosity and characterization properties of the comparative and inventive examples

| | U nit | CE 1 | CE 2 | CE 3 | IE 1 | IE 2 | IE 3 | IE 4 | IE 5 | IE 6 |
|---|---|---|---|---|---|---|---|---|---|---|
| Polyol | cps, r.t. | 755 | 2024 | 707 | 824 | 1057 | 1854 | 1360 | 1325 | 1607 |
| viscosity | | | | | | | | | | |
| Foam | kg/m³ | 42 | 42 | 39 | 43 | 43 | 44 | 41 | 43 | 40 |
| density | | | | | | | | | | |
| K factor | mW/m*K | 20.3 | 20.3 | 20.2 | 19.8 | 19.5 | 19.0 | 19.4 | 19.0 | 18.8 |
| (10° C.) | | | | | | | | | | |
| Compression | KPa | 175 | 190 | 243 | 241 | 223 | 220 | 186 | 236 | 322 |
| strength | | | | | | | | | | |

It is show by the comparison between comparative example 1 and comparative example 2 that the increase in the viscosity of the polyol used in the control formulation does not lead to reduced K factor, thus viscosity is not the essential feature for decreasing the K factor.

The comparison between the inventive examples 1-3 and the comparative examples 1-2 shows that the foams prepared by the hand foaming process exhibit a K factor gradually decreased along with the increase of the bisphenol A concentration. In Inventive Example 3, the foam was prepared with a bisphenol A/polyester polyol weight ratio of 15/85 and exhibited a K factor decrease at 10° C. of up to 1.3 mW/m*K as compared with the Comparative Examples 1 and 2. Besides, the compression strength at the foam rise direction increased greatly when the bisphenol A was introduced into the polyol package.

The comparison between the Inventive examples 4-5 and the Comparative examples 1-2 shows that 4,4′-oxydiphenol and 4,4′-biphenol can similarly decrease the K factor. In particular, the K factor was decreased by 0.9 mW/m*K in IE 4 which comprises 15 phr 4,4′-oxydiphenol and was decreased by 1.3 mW/m*K in IE 5 which comprises 10 phr 4,4′-biphenol. Besides, it can be seen from IE 5 that the introduction of 4,4′-biphenol can also lead to much better compression strength at the foam rise direction.

The comparison between IE 6 and CE 3 shows that in the experiments performed with the high pressure machine foaming process, the incorporation of bisphenol in the polyol package at a weight ratio (bisphenol A/polyester polyol) of 15/85 can significantly decrease the K factor (by 1.4 mW/m*K at 10° C.) and enhance the compression strength.

As can be seen from the above experiments, incorporation of bisphenol molecules (e.g., bisphenol A, 4,4′-oxydiphenol and 4,4′-biphenol) in the polyester polyol package of PIR/PUR system at a content of about 5-50 wt %, more preferably in the range of 10-30 wt % resulted in a polyol with good processability (e.g., having a viscosity of less than 2000 cps at ambient temperature), and when such a polyol is used in the preparation of PIR/PUR foams, a significant improvement of thermal insulation performance and compression strength at the foam rise direction was achieved.

The Inventive Examples 7-8 and Comparative Examples 4-8 were performed by a hand foaming technology or a high pressure machine foaming technology as follows:

The hand foaming technology comprises the steps of weighing the second isocycnate-reactive component (polyol), surfactant, flame retardant, catalyst and water according to the formulations of Table 5 in a paper cup and mixing them with a high speed mixer (from

Heidolph) at a rotation speed of 2000 r/m for 3 min to produce the “polyol package”; for Inventive examples 7-8, the solid bisphenol was also dissolved in the above said polyol package in a sealed bottle by heating at 80° C. for two hours; stiffing the polyol package at a speed of 2000 r/m for 5 min, and then cooling it to room temperature; adding a targeted amount of blowing agent into the paper cup under thorough mixing, followed by a subsequent addition of the desired amount of a polyisocyanate component into the paper cup. All the substances in the paper cup were immediately mixed by a high speed mixer at a speed of 3000 r/m for 5 seconds and poured into a mold of the size 10 cm×20 cm×30 cm that had been preheated to 40° C. and placed vertically along the length direction for foaming The foam was removed from the mold after about 30 min and placed in the lab bench overnight prior to physical properties testing.

The high pressure machine foaming technology was performed in Shanghai Dow Center (SDC) heavy lab with a high pressure machine (CANNON A-CMPT 40 FC PB). Flammable CP was used as the blowing agent. For the experiments comprising bisphenol A in the polyol package, bisphenol was dissolved into polyol package beforehand (by heating at 80° C. for 2 to 3 hours in a sealed bucket) to produce a clear solution (the polyol package). The polyol package was stirred by a high speed hand-mixer for 30 minutes, and then cooled to room temperature. A targeted amount of blowing agent was then added into the bucket and was mixed with the polyol package for additional 3 minutes. A 1.1 meter mold having a dimension of 110 cm×30 cm×5 cm was used for this machine foaming. The “polyol package” and corresponding polyisocyanate component, which were stored in separate pots, were rapidly mixed together with an impingement mixer (having a pump pressure of 100 bar) and introduced into the above stated 1.1 meter mold which had been preheated to 40° C. where the mixed substances were allowed to react and expand.

Comparative Example 4-8 and Inventive Example 7-8 were performed with the hand foaming technology and the high pressure machine foaming technology by using the formulations shown in Table 5. The formulations for all the Comparative Examples and Inventive Examples were particularly designed, and different amounts of the polyisocyanate component were used, to achieve an identical NCO index of 1.20. Besides, the amount of the other components were also tuned in order to maintain identical blowing agent percentage and catalyst percentage.

TABLE 5
The formulations of the Inventive Examples (IE) 7 to 8 and Comparative Examples
(CE) 4 to 8, wherein the unit for the amount of each ingredient was gram.

| | CE 4 | CE 5 | CE 6 | CE 7 | CE 8 | IE7 | IE8 |
|---|---|---|---|---|---|---|---|
| Recipe | g | g | g | g | g | g | g |
| V-482 | 41.25 | 41.25 | 41.25 | 41.25 | 41.15 | 41.35 | 41.35 |
| V490 | 7 | 7 | 7 | 7 | 7 | 7 | 0 |
| RA-640 | 10 | 10 | 10 | 5.65 | | | |
| PS3024 | 20 | 20 | 20 | 20 | | 21.75 | 21.75 |
| DSD 301.01 | 7.2 | 7.2 | 7.2 | 7.2 | 3 | 3 | 3 |
| BPA | | | | | 30 | 8 | 15 |
| Trichloropropyl | 5.65 | 5.65 | 5.65 | 10 | 10 | 10 | 10 |
| phosphate (TCPP) | | | | | | | |
| Triethyl phosphate | 4 | 4 | 4 | 4 | 4 | 4 | 4 |
| (TEP) | | | | | | | |
| AK8863 | 2 | 2 | 2 | 2 | 2 | 2 | 2 |
| PC-5 | 0.25 | 0.25 | 0.25 | 0.25 | 0.25 | 0.2 | 0.2 |
| PC-8 | 0.95 | 0.95 | 0.95 | 0.95 | 0.95 | 0.9 | 0.9 |
| TMR-30 | 0.3 | 0.3 | 0.3 | 0.3 | 0.3 | 0.3 | 0.3 |
| Water | 1.4 | 1.4 | 1.4 | 1.4 | 1.4 | 1.4 | 1.4 |
| Sum | 100 | 100 | 100 | 100 | 100.05 | 99.9 | 99.9 |
| 245fa | 18 | 14 | 6 | 6 | 6 | 6 | 6 |
| CP | 2 | 5 | 9 | 9 | 9 | 9 | 9 |
| CP/245fa weight | 1:09 | 5:14 | 3:02 | 3:02 | 3:02 | 3:02 | 3:02 |
| ratio | | | | | | | |
| Papi 135 | 132 | 132 | 132 | 125 | 136 | 125 | 125 |
| Iso idex | 1.20 | 1.20 | 1.20 | 1.21 | 1.19 | 1.20 | 1.20 |

The viscosity of the polyol, the thermal conductivity (K factor), density and compression strength of the resultant rigid PIR/PUR foams were characterized and summarized in Table 6.

TABLE 6
Polyol viscosity and characterization properties
of the comparative and inventive examples

| Recipe | CE 4 | CE 5 | CE 6 | CE 7 | CE 8 | IE 7 | IE 8 |
|---|---|---|---|---|---|---|---|
| Viscosity of Polyol system | 550 | 620 | NA | 510 | 3609 | 920 | 1067 |
| with Blowing agent (Cps at | | | | | | | |
| 25 deg C.) | | | | | | | |
| Hand mixing testing | | | | | The | | |
| Core density kg/m³ | 38.7 | NA | NA | 38.5 | viscosity | 37 | 38 |
| Compressive strength, kPa | 188 | NA | NA | 190 | is to0 | 191 | 192 |
| K factor, 23° C. | 20.5 | NA | NA | 21 | high to | 19.9 | 19.7 |
| K factor, 10° C. | 19 | NA | NA | 19.6 | achieve | 18.4 | 18.2 |
| HP machine testing | | | | | a good | | |
| JPW (Just filled weight, g) | 645 | 650 | NA | NA | mixing to | 615 | NA |
| Injection weight (g) | 708 | 718 | | | produce | 683 | |
| OP(Over packing) % | 10.6 | 10.5 | NA | NA | a foam | 11.1 | NA |
| Core density kg/m³ | 39 | 40 | NA | NA | with | 36 | NA |
| Compressive strength, kPa | 194.7 | 197.6 | NA | NA | good | 185 | NA |
| K factor, 23° C. | 19.6 | 19.7 | NA | NA | quality | 19.3 | NA |
| FR HF-1 (GB/T8332-2008) | Pass | Pass | Not | Pass | | Pass | Pass |
| | | | pass | | | | |

As can be seen from the above experimental results, the formulation of the blowing agent can be properly modified in the PIR/PUR system prepared by using bisphenol as part of the polyol package. In particular, a large portion of the expensive 245Fa can be replaced with CP to save the cost of the raw materials. The comparison between Comparative Example CE1,

Comparative Example CE2 and Comparative Example CE3 shows that a formulation having a high CP/245Fa weight ratio cannot produce a foam passing the HF-1 flame retardant test according to GB/T8332-2008 and meeting the FR requirement. The Comparative Example CE4, which has a CP/245Fa weight ratio of 3:2, needs to comprise more TCPP to pass the HF-1 flame retardant test and has a deteriorated insulation performance (represented by an increased K factor) when compared with the Comparative Example CE1. Comparative Example CE5 shows that the amount of BPA has to be particularly designed, otherwise suitable viscosity and processability cannot be achieved. As compared with the Comparative Example CE1, Comparative Example CE2, Comparative Example CE3, Comparative example CE4, and Comparative Example CE5, the Inventive Examples IE1 and IE2, which comprise a blowing agent consisting of CP/245Fa (3:2), a proper amount of BPA (5 wt %-20 wt % in the polyol) and flame retardant (e.g., TCPP and/or TEP) (10 wt % -25 wt % in polyol) in the polyol package, could achieve low K factor (19.3 at 23° C. in HP machine trial foam) while keep excellent FR performance (Pass HF-1 test). Moreover, the innovation formulations of the Inventive Examples can achieve a JPW of 5% less as well as lower final injection weight while keeping an excellent compressive strength.

In view of the above, a polyol package comprising 5-20 wt % of bisphenol molecules (e.g., bisphenol A, 4,4′-oxydiphenol and 4,4′-biphenol), 10-25 wt % of flame retardant (e.g., TCPP and/or TEP), and a mixed blowing agent system of CP and 245Fa (having a CP/245Fa ratio by weight of less than 4:1) can achieve good processability represented by a viscosity at ambient temperature of less than 2000 cps. When such a polyol package is used in the preparation of PUR/PIR foam which can be used for water heater, a significant improvement of thermal insulation performance was achieved while keeping excellent FR performance Meanwhile, the foam derived from the inventive formulations can produce a comparable compression strength with a 5% lower density when compared with the control formulation. Thus, the innovation formulation of the present disclosure leads to 5% less JPW as well as lower final injection weight to fulfill the water heater container while keeping excellent compressive strength.

It is further noted that terms like “preferably,” “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A composition for preparing polyisocyanurate and polyurethane foams, comprising:
A) a first isocyanate-reactive component comprising a bisphenol represented by Formula 1, 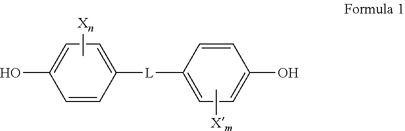
wherein L is a direct bond, an oxygen atom, a sulfur atom, 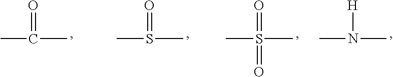
—CH═CH— or a C₁ to C₈ alkylene group; X and X′ are independently selected from the group consisting of hydrogen atom, halogen atom and C1-C8 alkyl groups; n and m are independently an integer of 0, 1, 2, 3 or 4;
B) a second isocyanate-reactive component different said first isocyanate-reactive component, wherein the second isocyanate-reactive component comprising one or more polyols having a hydroxyl value of 100 to 700 mg KOH/g;
C) a polyisocyanate component comprising one or more compounds having at least two isocyanate groups; and
wherein the amount of the bisphenol is from 5 wt % to 50 wt %, based on the combined weight of the first and the second isocyanate-reactive component.

2. The composition according to claim 1, wherein L is a direct bond, an oxygen atom or an alkylene group selected from the group consisting of di(methyl)methylene, methylene, 1,1′, 2, 2′-tetra(methyl)ethylene, ethylene, 1, 1′, 2, 2′, 3, 3′-hexa(methyl)propylene, propylene, butylene, pentamethylene, hexamethylene and heptamethylene; and/or
X and X′ are independently selected from the group consisting of hydrogen atom, halogen atom, methyl, ethyl, n-propyl, i-propyl, n-butyl, s-butyl, i-butyl and t-butyl.

3. The composition according to claim 1, wherein the amount of the bisphenol is 5 wt % or larger and less than 50 wt %, or from 10 wt % to 30 wt %, or from 5 wt % to 25 wt %, or from 5wt % to 15wt %, based on the combined weight of the bisphenol and the polyol component.

4. The composition according to claim 1, wherein the polyol has a hydroxyl value of 150 to 700 mg KOH/g, 200 to 700 mg KOH/g, 210 to 640 mg KOH/g, or 240 to 640 mg KOH/g, and
the polyol is selected from the group consisting of C2-C16 aliphatic polyhydric alcohols comprising at least two hydroxy groups, C6-C15 cycloaliphatic or aromatic polyhydric alcohols comprising at least two hydroxy groups, C7-C15 araliphatic polyhydric alcohols comprising at least two hydroxy groups, aromatic or aliphatic polyester polyols having a molecular weight from 100 to 10,000, aromatic or aliphatic polyether polyols having a molecular weight from 100 to 4,000 and combinations thereof.

5. The composition according to claim 1, wherein the compounds comprising at least two isocyanate groups are selected from the group consisting of:
C₄-C₁₂ aliphatic polyisocyanates comprising at least two isocyanate groups,
C₆-C₁₅ cycloaliphatic or aromatic polyisocyanates comprising at least two isocyanate groups,
C₇-C₁₅ araliphatic polyisocyanates comprising at least two isocyanate groups, and
isocyanate prepolymers obtained by reacting the C₄-C₁₂ aliphatic polyisocyanates comprising at least two isocyanate groups, C₆-C₁₅ cycloaliphatic or aromatic polyisocyanates comprising at least two isocyanate groups or C₇-C₁₅ araliphatic polyisocyanates comprising at least two isocyanate groups with one or more isocyanate-reactive compounds selected from the group consisting of ethylene glycol, 1,2-propanediol, 1,3-propanediol, 1,3-butanediol, 1,4-butenediol, 1,4-butynediol, 1,5-pentanediol, neopentylglycol, 1,2-, 1,3- and 1,4-bis(hydroxy-methyl) cyclohexanes, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols.

6. The composition according to claim 1, wherein the compounds comprising at least two isocyanate groups are selected from the group consisting of:
m-phenylene diisocyanate, 2,4-toluene diisocyanate, 2,6-toluene diisocyanate, diphenylmethanediisocyanate, hydrogenated diphenylmethanediisocyanate, carbodiimide modified diphenylmethane-diisocyanate, hexamethylene-1,6-diisocyanate, tetramethylene- 1,4-diisocyanate, cyclohexane-1,4-diisocyanate, hexahydrotoluene diisocyanate, naphthylene- 1,5 -diisocyanate; and
polymerization product of diphenylmethanediisocyanate with one or more isocyanate-reactive compounds selected from the group consisting of ethylene glycol, 1,2-propanediol, 1,3-propanediol, 1,3-butanediol, 1,4-butenediol, 1,4-butynediol, 1,5-pentanediol, neopentylglycol, 1,2-, 1,3- and 1,4-bis(hydroxy-methyl) cyclohexanes, 2-methylpropane-1,3-diol, methyl-pentane-diols, diethylene glycol, triethylene glycol, tetraethylene glycol, polyethylene glycol, dipropylene glycol, polypropylene glycol, dibutylene glycol and polybutylene glycols, wherein the polymerization product comprises at least two terminal isocyanate groups.

7. The composition according to claim 1, wherein the compounds comprising at least two isocyanate groups have a viscosity of no more than 5 Pa·s at 25° C., or no more than 2 Pa·s at 25° C.

8. The composition according to claim 1, wherein the composition comprises 10-50 wt %, or 15-40 wt %, or 20-35 wt %, or 20-70 wt %, or 30-60 wt %, or 35-50 wt % of the second isocyanate-reactive component B) and 45-90 wt %, or 60-85 wt %, or 65-80 wt %, or 30-80 wt %, or 40-80 wt %, or 50-75 wt % of the polyisocyanate component C), based on the total amount of the composition; and
the molar ratio between the isocyanate groups and the combined hydroxyl groups in the composition is at least 1.0, or from 1.0 to 6, or from 1.1 to 6, or from 1.2 to 4.

9. The composition according to claim 1, wherein the composition comprises a blowing agent D) selected from the group consisting of water, hydrocarbons and hydrofluorocarbons; and
the amount of the blowing agent D) is from 0.01 wt % to 40 wt %, or from 10 wt % to 25 wt %, based on the total weight of the composition minus the weight of the polyisocyanate component C).

10. The composition according to claim 9, wherein the blowing agent D) comprises a mixture of 25-80 wt % hydrocarbon and 20-75 wt % of hydrofluorocarbons, based on the total amount of the blowing agent D).

11. The composition according to claim 1, wherein the composition comprises a catalyst E) selected from the group consisting of tertiary amines; tertiary phosphines; metal chelates; ferric chloride; stannic chloride; organic acid salts of alkali metals, alkaline earth metals, Al, Sn, Pb, Mn, Co, Ni and Cu; metal complexes of tetravalent tin, trivalent and pentavalent As, Sb and Bi; and metal carbonyls of iron and cobalt; and
the amount of the catalyst E) is from 0.01 wt % to 10 wt %, or from 0.5 wt % to 5 wt %, based on the total weight of the composition minus the weight of the polyisocyanate component C).

12. The composition according to claim 1, wherein the composition comprises a flame retardant selected from the group consisting of trichloropropyl phosphate, triethyl phosphate and a combination thereof; and
the amount of the flame retardant is from 0.01 wt % to 20 wt %, or from 0.5 wt % to 15 wt %, or from 1 wt % to 10 wt %, based on the total weight of the composition minus the weight of the polyisocyanate component C).

13. The composition according to claim 1, further comprising additives selected from the group consisting of co-catalyst, surfactant, toughening agent, flow modifier, adhesion promoter, diluent, stabilizer, plasticizer, catalyst de-activators and mixtures thereof;
wherein the total amount of the additives is from 0.01 wt % to 10 wt %, or from 0.5 wt % to 5 wt %, based on the total weight of the composition minus the weight of the polyisocyanate component C).

14. A polyisocyanurate and polyurethane foam prepared with the composition according to claim 1, wherein the polyisocyanurate and polyurethane foam is formed by reacting the first isocyanate-reactive component A) and the second isocyanate-reactive component B) with the polyisocyanate component C).

15. A method for preparing a polyisocyanurate and polyurethane foam with the composition according to claim 1, comprising a step of reacting the first isocyanate-reactive component A) and the second isocyanate-reactive component B) with the polyisocyanate component C).
